(19) United States
(12) Patent Application Publication
(10) Pub. No.: US 2006/0227958 A1
(43) Pub. Date: Oct. 12, 2006

(54) Intelligent wrong number intercept handler

(76) Inventors: Suraj P. Tschand, Morganville, NJ (US); Ajay P. Tschand, Manalapan, NJ (US)

Correspondence Address: SURAJ P. TSCHAND, 1230 HIGHWAY 34, ABERDEEN, NJ, 07747, US

(21) Appl. No.: 11/010,592

(22) Filed: Mar. 31, 2005

(51) Int. Cl. H04M 3/42

(52) U.S. Cl. 379/213.01; 379/212.01

(57) ABSTRACT

When people dial a wrong international telephone number from a regular phone or a mobile phone, the telephone switches intercept the call and the let the caller know that the number they have dialed is incorrect and they should try again. Generally the caller dials the same telephone number and receives the same message. The present invention analyses the dialed telephone number and based on a knowledge base, plays an intelligent message to the caller and instructs the caller what to dial, and what the different parts of the telephone number mean. The caller has a much better idea of dialing international telephone numbers, after listening to the invention's intelligent messages.

### BACKGROUND OF THE INVENTION

In general in the USA, when a caller wants to make an international call, he must dial 011 followed by the country code, city code and subscriber's local phone number. In many cases, the caller knows the local phone number but have no idea about the country code, city code, and the order the number should be dialed.

Using the International Telecommunications Union (ITU) E.164 International Public Telecommunication Numbering Plan, a U.S. caller who wants to make an international call must dial 011 followed by the 1 to 3 digits country code (CC), followed by the subscriber number (SN), where the first few digits of the SN is called the National Destination Code (NDC). In most cases, the NDC can also be considered as the City Code. The number must be dialed exactly as required by the national numbering plan, otherwise the call will not go through.

Each country has its own unique national numbering plan, and it is not consistent from country to country. In many countries, the National Destination Code (NDC) digit length and subscriber number length of digits vary from area to area. Therefore it becomes extremely confusing to properly dial international numbers, and many callers end up dialing incorrectly. To add to the confusion many countries have modified their numbering plans to accommodate the mobile carriers and the different promotional schemes. In fact in many cases the NDC means nothing more than a different mobile carrier or a different service, rather than identifying a specific city or region of the country. Many callers are inundated by the different schemes deployed in many countries.

This causes frustration for the callers and puts tremendous load on the international voice networks. Most of the work done by the network is non-revenue generating and in fact very costly for the network operators.

In addition most of the telephone switches in the world are very old and they use a very rudimentary way of routing telephone calls. They look at the first couple of digits of the dialed number and route the calls. They can not be upgraded to check for the number of digits dialed and check the number before routing the calls. Therefore the caller must know exactly how to dial the number correctly, otherwise the call will not get completed or will have an uninformative operator intercepted message played out to them (For example a message that says, “I'm sorry, the number you have dialed is incorrect” or “I'm sorry the number you have dialed does not exist”.

As well, most of the international switches play informational messages in the language of the destination country regardless of where the call has originated from. The switches do not give any choice to the caller to select the language the messages should be played in. Not understanding the operator's message, callers continuously try dialing the number in the same format, not realizing their mistake while dialing.

The shear number of wrong telephone numbers, dialed, causes the telephone companies to lose tremendous amounts of revenue. Furthermore it clogs the telephone networks to the point where even correctly dialed numbers do not go through.

### SUMMARY OF THE INVENTION

The present invention provides improved wrong number intercept handling by analyzing the dialed number and the calling party number, and based on that plays a message to the caller in the most appropriate language.

The invention is a computer based system that has the ability to connect to IP Networks including the Internet, the telephone networks, and databases. It also has the necessary hardware to play digitized voice files, decode multi-frequency tones, and support the different telecom in band and out of band signaling protocols.

The invention supports the different telecommunications topologies that are deployed in today's world. The Intercept Handler can work with the three basic telecom network implementations. First the Intercept Handler can work with the Public Switched Telephone Network (PSTN) directly. Second the Intercept Handler can work with System Signaling 7 (SS7) or C7, and thirdly the Intercept Handler can work with the Voice over IP and other Packet Switched Networks.

The telephone switch will send the dialed number of the call to the invention. From the dialed number, the invention extracts the country code and the subscriber number (SN). (e.g., if the dialed number is 011-33-1-49525354, the country code is 33 and the SN of the number is 149525354). It checks the pattern of the SN including the National Destination Code (NDC) and remaining digits of the subscriber number to make sure it is consistent with the country code. If the number of digits and the pattern are valid for the country it declares the number as correct and lets the telephone switch complete the call. If the SN of the dialed number is not consistent with the country code, then the invention goes through a series of analyses.

For example if the caller dials 011-33-1-49525354, the invention extracts the country code 33 which corresponds to France, and from the SN, the number 1 49525354. The invention looks through it's database and determines that 33 is a valid country code, 1 is a valid National Destination Code(NDC) (Île-de-France (Paris area)) and the remaining 8 digits is consistent with the national numbering plan for France and the Île-de-France (Paris area) NDC. Therefore it is determined to be a valid number format. If the dialed number was mistakenly dialed as 01133149525354, the invention extracts the country code 33 which corresponds to France, and the NDC of ‘1’, and the remaining 7 digits. It is determined that the SN of the dialed number consist of 8 digits instead of 9 digits, and that this does not match with the National Numbering Plan for France, and the Île-de-France (Paris area) NDC. The invention plays a message in French and/or the language of the country the caller is calling from and lets the caller know that they must dial 33 for the France country code and then the one digit region code, and the eight digits of the subscriber's phone number.

In other scenarios once the invention has determined that the dialed number is not valid, it checks the pattern of the SN. It looks for the most likely country code for SN of the dialed number. It comes up with the best fit country code and plays a message in the language of the most likely country. It lets the caller know that the country code that they have dialed may not be correct. Then it lets them know how to correctly dial the phone number.

For example if the caller dials 011-93646743500, the invention extract the country code 93 which corresponds to Afghanistan, however the pattern of the SN does not correspond to Afghanistan. The pattern of the SN of the dialed number 646743500 is valid for many countries, but the invention determines that Italy is the most likely country the caller had in mind when dialing the number. The invention makes an intelligent guess, and concludes that the caller instead of dialing country code 39 had dialed 93. The invention plays a message in Italian, Farsi (Afghan Language) & language of the country the caller is calling from and lets the caller know they dialed a wrong number, and possibly a wrong country code. It then informs the caller they must dial 011 followed by the country code 39, the city code 6, and the eight digits subscriber local number.

Many callers from foreign countries use the International Telecommunications Union (ITU) Recommendation E.164 numbering plan when making calls. Instead of using 011, they dial 00 followed by the Country Code and then the SN of the number. If the caller in the U.S. dials an international number based on the E.164 protocol, the invention will play a message to the caller of how to properly dial the number. The invention explains to the caller how to properly dial to the destination they are calling. It further explains that from where they are calling to dial an international number they need to dial 011 instead of 00. Once the caller understands the logic behind the numbering plan, they are able to comply and dial correctly.

This invention uses a multi-dimensional database, which contains every countries numbering plan, with complete details on the valid NDC's and SN digit lengths. There are up to 500,000 patterns in the database that are constantly updated with the proper national numbering plans data. The database also contains the minimum and maximum number of digits for the Subscriber Number of the Country Code. Lastly, the database contains the language that corresponds to this country code and NDC. This allows the Intercept Handler to determine the language in which to play the prompts.

### BRIEF DESCRIPTION OF THE DRAWINGS AND TABLES

FIG. 1 shows the basic format of the data which software logic uses to check the number dialed.

FIG. 2 shows the topology for the Public Service Network Switches (PSTN) and through the Intelligent Wrong Number Intercept Handler.

FIG. 3 shows the topology for a Public Service Network Switch (PSTN), ANSI System Signaling (SS7) or ITU C7 Network, and through the Intelligent Wrong Number Intercept Handler.

FIG. 4 shows the topology for the Internet/Intranet and Intelligent Wrong Number Intercept Handler.

FIG. 5 shows the software logic that checks the dialed number and plays the proper intercept message to the caller.

### DETAILED DESCRIPTION OF THE EMBODIMENT

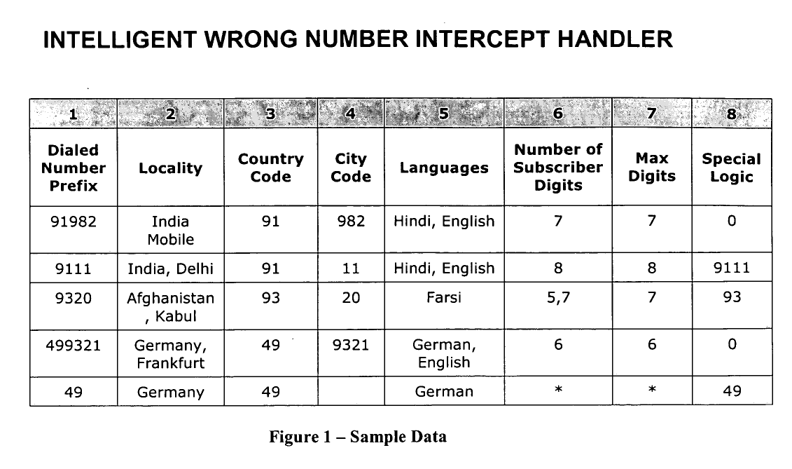

FIG. 1 shows the basic information needed for the logic of the system to work. The first column corresponds to the initial digits in the dialed number (usually the Country Code and NDC), which is used for the basic search. The second column in the table describes the geographical area that corresponds to the number. The third column specifies the country code. The fourth column in FIG. 1 corresponds to the city NDC. The fifth column corresponds to the most likely language the caller would want to hear the announcement in. The sixth column shows the minimum subscriber digits that are supported in the destination switch. The seventh column shows the maximum number of digits for the subscriber. The eighth column has the identification for the special logic that must be used to determine the validity of the dialed number.

The data in the table can be updated dynamically, and there is no need to shut down the system to upload or update the data. The software logic to correspond to a pattern can be added or modified dynamically.

FIG. 1 is an example of data. For example, consider the fourth line, with a prefix of 449321. This shows that the number following this number corresponds to a phone subscriber in Frankfurt, Germany. The NDC (city code) is 9321, which must be followed by a 6 digit subscriber number. The intercept message is played in German and/or in the language of the calling party.

This invention supports MySQL, Microsoft SQL Server, Oracle, IBM DB2, and all ODBC-compliant databases.

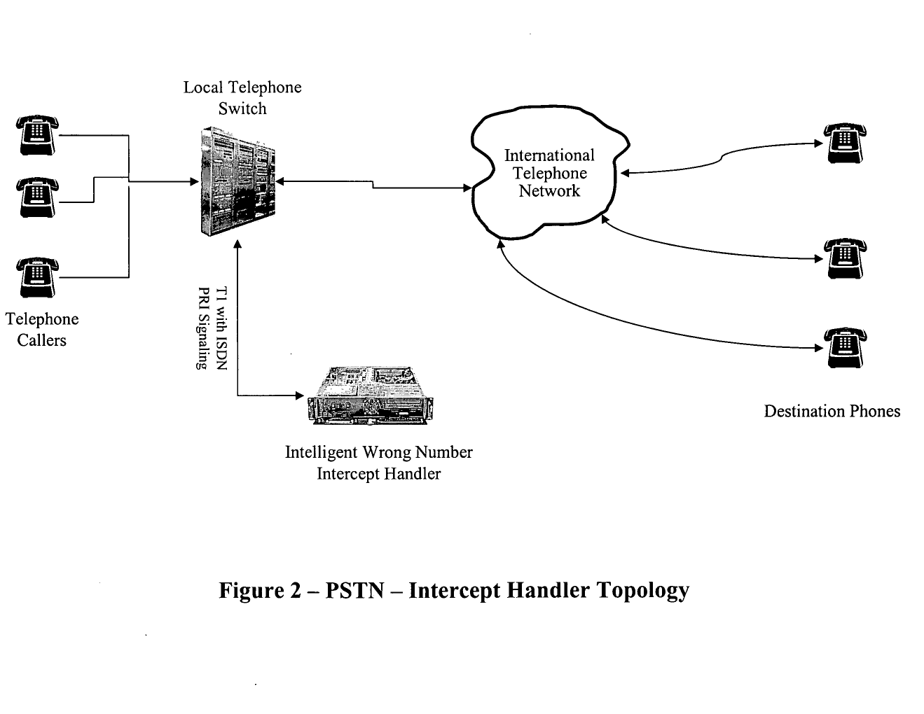

FIG. 2 displays the position of the Intelligent Wrong Number Intercept Handler (Invention) with respect to the rest of the telephone network. The Intercept Handler is a computer-based system that connects to local telephone switches through the Integrated Services Data Network (ISDN) Primary Rate Interface. The Intercept Handler has a Digital Signal Processor (DSP) that allows it to play a digitized voice file. The voice editing software of the Intercept Handler allows one to record different voice messages that are digitized and played back to the callers. The digitized voice messages are language-independent. Furthermore, the software of the Intercept Handler has the ability to play different digitized voice segments. Thus, by combining numbers, words, and currency amounts, the Intercept Handler plays dynamically created sentences.

The Intercept Handler can send and receive signals from the local telephone switch. The caller first dials the international phone number from his phone. The local telephone switch then sends the call to the Intelligent Wrong Number Intercept Handler, which checks the dialed number. If the number is correct, it sends an ISDN signal to the telephone switch, instructing it to route the call through the International Telephone Network If the dialed phone number is incorrect, the Intelligent Wrong Number Intercept Handler accepts the call and establishes a voice path with the caller. The Intercept

Handler plays a message instructing the caller how to dial the phone number based on what the dialed number is.

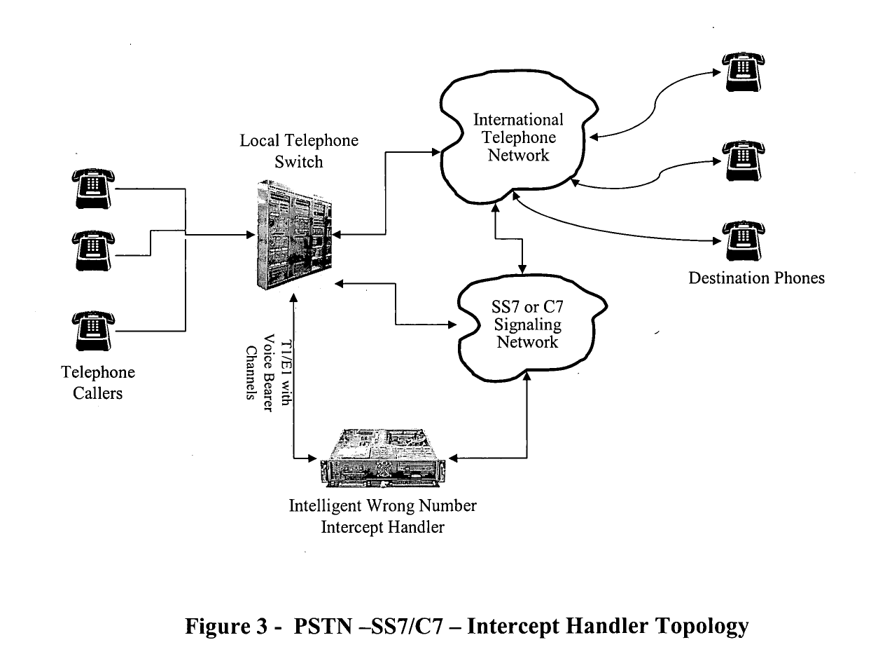

FIG. 3 demonstrates how the Intercept Handler interfaces with American National Standard Industries (ANSI) System Signaling (SS7) and International Telecommunications Union (ITU) C7 Network. When a caller makes an outbound call, the SS7 or C7 network sends a signal containing the dialed number (DNIS) and calling party number (ANI) to the Intercept Handler. The Intercept Handler sends a signal back to the SS7 network if the DNIS is incorrect. The SS7 network instructs the proper local switch to connect the calling party to the Intercept Handler. At this point the Intercept Handler plays the message to the caller based on the called party number.

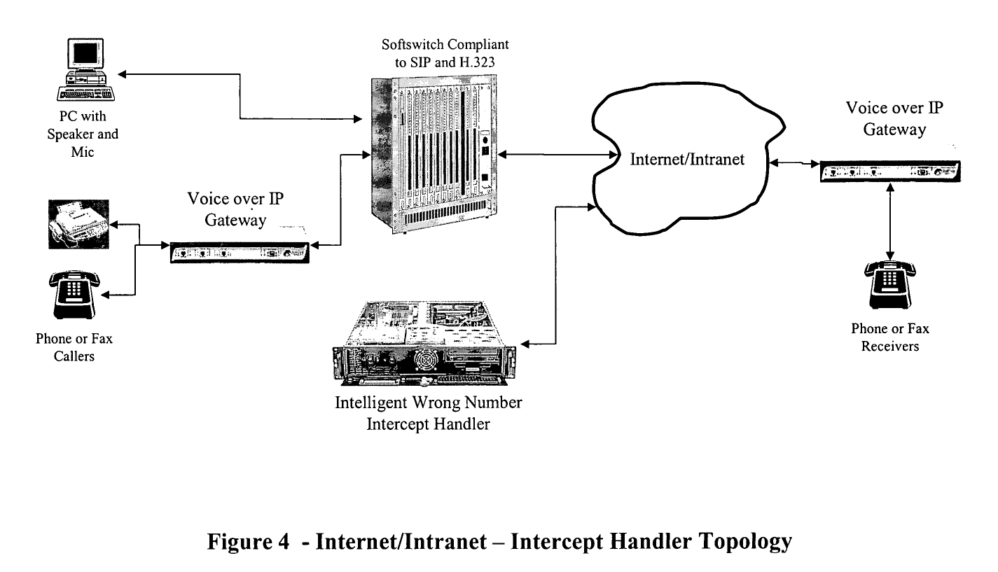

FIG. 4 shows how the Intercept Handler interfaces with a Voice Over IP network. The Intercept Handler supports the H.323 and Session Initiation Protocols (SIP). These protocols are similar to SS7 and C7 and are used for Internet voice applications. The core of a Voice Over IP network is the soft-switch that provides control for voice communications over the EP network. In order to connect Plain Old Telephones (POTS) to the EP network, one must use the Voice over IP (VoIP) Gateways. The function of the gateway is to convert POTS signals to IP signals. A computer with proper hardware, however, can directly connect to the IP network.

When a caller makes a call, the VoIP gateway routes the call to the Intercept Handler. The Intercept Handler checks the dialed number and determines whether or not it is correct. If the number is correct, it simply sends a signal to the gateway, instructing it to route the call through the proper channels. If the dialed number is incorrect, the Intercept Handler accepts the call and plays the intercept message to the callers, instructing them how to correctly dial the call.

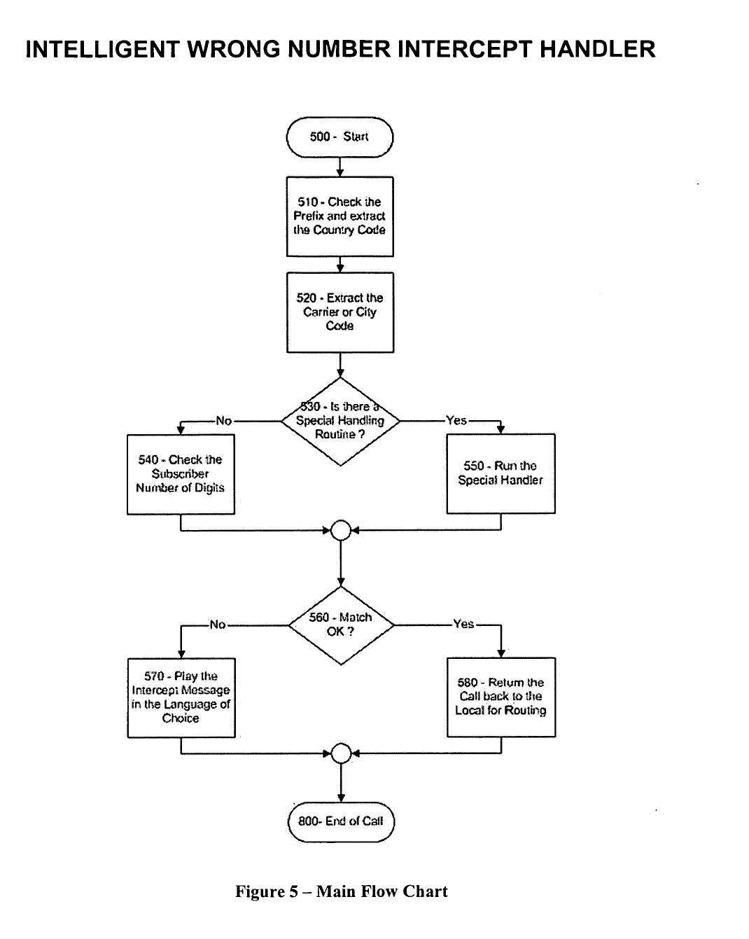

FIG. 5 is a flowchart of the software logic. The local telephone company's switch routes the call to the Intercept Handler. The logic starts at step 500. Based on the Prefix of the dialed number (DNIS), the Intercept Handler retrieves the data record and extracts the country code at step 510. At step 520, the logic extracts the NDC of the number. Based on the data in the database, the logic checks to see if a special handling routine should be run at step 530. If yes, at step 550 the logic executes the special handler which decides whether or not the DNIS is correct. If the DNIS is incorrect, it plays a message to the caller. If there is no need to run the special handler at step 530 then the logic checks the string length (number of digits) of the subscriber portion of the DNIS and decides whether or not the number is correct.

At step 560, the logic checks if the DNIS is correct based on the logic given throughout this document. If the dialed number is correct, the Intercept Handler returns the call back to the switch and allows it to handle the call (step 580). If the dialed number is incorrect, the Intercept handler plays a message to the caller and informs the caller how to dial the number (step 570). Then the Intercept Handler disconnects the call (step 800).

1. The Intelligent Wrong Number Intercept Handler analyzes the incorrect Dialed and Calling Party Telephone Numbers and plays an intelligent message to the caller to educate him how to correctly dial the international telephone number in the future.

2. The Intelligent Wrong Number Intercept Handler determines the best language to play the intercept message in.

3. The Intelligent Wrong Number Intercept Handler allows the caller to select the language the intercept message should be played in. It also allows the caller to press a touch-tone key and listen to the intercept message again.
